(19) United States
(12) Patent Application Publication
(10) Pub. No.: US 2025/0322425 A1
(43) Pub. Date: Oct. 16, 2025

(54) CREDIT CARD REWARD METHOD

(71) Applicant: Constantin Ken Digalakis, Toronto (CA)

(72) Inventor: Constantin Ken Digalakis, Toronto (CA)

(21) Appl. No.: 18/633,626

(22) Filed: Apr. 12, 2024

(51) Int. Cl. G06Q 30/0226; G06Q 40/10

(52) U.S. Cl. CPC G06Q 30/0233; G06Q 40/10

(57) ABSTRACT

A reward method for users of a credit card wherein the method of the present invention encompasses embodiments that provide monetary donations to designated organizations and entry into routine prize drawings. The method of the present invention in a first embodiment provides identification of an organization wherein the credit card holder desires to donate monetary donations. The credit card issuer assigns points to every dollar spent wherein the points are subsequently converted to dollars for donation to the identified organization. A tax receipt for charitable donation is automatically sent to the credit card holder. A second embodiment of the present invention includes accumulation of points based on dollars spent with the issued credit card wherein the points are converted into entry tickets for a cash prize drawing. The cash prize drawings are conducted by the credit card issuer at predetermined intervals and are for various amounts.

### FIELD OF THE INVENTION

The present invention relates generally to customer reward systems, more specifically but not by way of limitation, a reward method for users of a credit card wherein the method of the present invention encompasses embodiments that provide monetary donations to designated organization and entry into routine prize drawings.

### BACKGROUND

Credit card points are one of the main types of rewards that are issued to credit card users. In addition to point credit card companies will also issue cash back and airline mileage rewards in exchange for dollars spent utilizing the credit card. Credit card users earn points by making purchases typically after meeting initial spending requirements. Credit card point systems typically offer at least one point per dollar spent on all purchases. Some cards offer a flat earning rate, while others reward certain purchases more. Cardholders can redeem credit card points for items such as but not limited to travel, merchandise, cash back, gift cards. Typically, points will be worth a predetermined value when redeemed, and the value differs amongst credit card issuers. Issuers offer different options with different redemption prices. By way of example but not limitation, points may be worth more toward travel than cash back.

Credit card points are usually worth about one cent each but the value can vary, depending on the credit card company and what a cardholder applies the points towards. With some cards, points will be worth the same amount, however with others, a cardholder is incentivized to redeem for certain items. Credit card points, like miles and unlike cash back, can be devalued. Since the credit card issuer dictates how many points it costs to redeem for each option, the issuer controls the value of the points. For credit card holders it is advised that the cardholder redeems points often to minimize the chance of devaluation. The point redemption process differs by issuer but most are typically executed online and are applied to cash, travel or gift cards. No current card provider utilizes points to make monetary donations to designated organization providing the card user with applicable tax impact information. Additionally, no credit card issuer applies points to a card issuer sponsored drawing performed on a routine basis wherein the drawings provide cardholders with a cash award.

Accordingly, there is a need for a credit card reward method that provides a credit card holder an option of enrolling in programs that facilitate donations to a designated organization as well as a program that provides entry into a card issuer sponsored drawing for a cash prize.

### SUMMARY OF THE INVENTION

It is the object of the present invention to provide a credit card reward method that is operable to facilitate a donation to a designated organization based on dollars spent on an issued credit card wherein the method of the present invention includes the step of collecting a database of points wherein the points are based on the amount purchased with the credit card.

Another object of the present invention is to provide a credit card reward method that provides card holders an entry into a routine cash prize drawing wherein the present invention includes generation of points based on purchases wherein each point is an entry into the cash prize drawing.

A further object of the present invention is to provide a credit card reward method that is operable to facilitate a donation to a designated organization based on dollars spent on an issued credit card wherein the present invention includes generation of applicable tax information for annual donations made by the credit card holder.

Yet a further object of the present invention is to provide a credit card reward method that provides card holders an entry into a routine cash prize drawing wherein the method of the present invention includes generation of a points database for collection of all of the points earned and applied to the routine cash prize drawing conducted by the card issuer.

Still another object of the present invention is to provide a credit card reward method that is operable to facilitate a donation to a designated organization based on dollars spent on an issued credit card wherein the points accumulated have an assigned dollar value that is donated to the designated organization.

An additional object of the present invention is to provide a credit card reward method that provides card holders an entry into a routine cash prize drawing wherein the cash prize winner is identified by a specific generated number linked to the credit card holders account number.

Yet a further object of the present invention is to provide a credit card reward method that is operable to facilitate a donation to a designated organization based on dollars spent on an issued credit card wherein the method of the present invention provides automated tabulating of dollars spent and generates the point monetary value thereof for distribution to the designated organization.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a flowchart of a first embodiment of the present invention; and

FIG. 2 is a flowchart of a second embodiment of the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a credit card reward method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

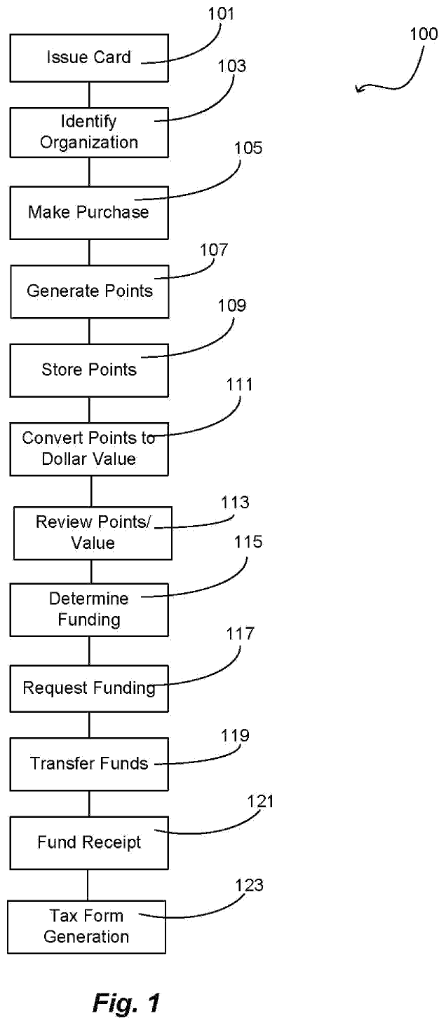

Referring in particular to the Figures submitted herewith, the credit card reward method 100 is operable to provide a credit card holder alternate options for rewards wherein the rewards are based upon dollars spent utilizing the issued credit card. Referring in particular to FIG. 1 submitted herewith, the credit card reward method 100 facilitates payment to a designated organization at predetermined intervals from a credit card holder wherein the payments precipitate from dollars spent on a credit card by a user thereof. It should be understood within the scope of the present invention that the subsequent method applies to a multitude of users. In step 101, a credit card issuer issues a credit card to a user. Step 103, the user will identify an organization to which the user prefers to direct monetary donations to based upon the spending performed on the issued credit card. It should be understood within the scope of the present invention that the organization could be a direct organizations that benefits from the donation or the organization could be an advisory organization that could be responsible for directing the monetary contributions to one or more organizations.

In step 105 the user of the credit card makes a purchase of a good or service utilizing the credit card. Step 107, the aforementioned purchase generates a prescribed amount of points. In step 109, the points generated by the card holder are stored in a relational database or similar suitable location. In step 111, the stored points are converted to a dollar value. It should be understood within the scope of the present invention that the dollar value for each point is predetermined upon issuance of the credit card. By way of example but not limitation, the points could be worth five cents for every dollar purchased utilizing the credit card. Step 113, the card holder is provided a user interface via the Internet wherein the card holder can execute a review of the dollars spent, points earned and the value for the points. In step 115, the credit card holder determines the funding interval for the identified organization. The funding interval stipulates how often the identified organization receives a monetary donation based upon the point conversion to dollars wherein the points are earned by purchases of the credit card holder. By way of example but not limitation, the funding interval could be monthly or quarterly. Step 117, the credit card holder will request funding for the identified organization wherein the funds are equivalent to the point to dollar conversion ratio stipulated by the credit card issuer. In step 119, the credit card issuer will transfer the requested funds to the identified organization. Step 121, the identified organization receives the designated funds from the credit card issuer. In step 123, the credit card issuer generates on at least an annual basis a tax donation form to the credit card holder that specifically identifies the amount donated to the identified organization.

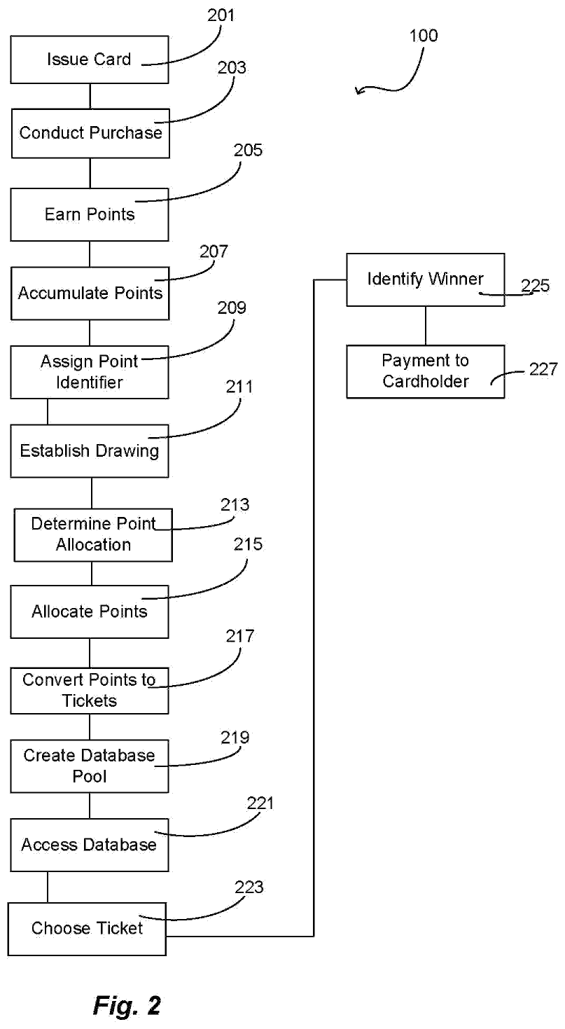

Now referring in particular to FIG. 2, an alternate embodiment of the present invention is illustrated therein. In step 201, the credit card issuer issues a credit card to a credit card holder. Step 203, the credit card holder utilizes the issued credit card to conduct a purchase of a good or a service. In step 205, the credit card holder earns points for every purchase performed with the issued credit card. Step 207, the credit card holder accumulates points in an account designated for the credit card holder. In step 209, the credit card issuer assigns a points identifier for the credit card holder in order to establish and identify ownership of the points. By way of example but not limitation, the points identifier could be the credit card holder's account number or a portion thereof. Step 211, the credit card issuer establishes a drawing. The drawing comprises a cash drawings wherein the drawing can vary both in the amount and how often the drawing is conducted. In step 213, the credit card issuer determines the point allocation for the credit card holder. In this step the quantity of points for each entry ticket is determined. It should be understood within the scope of the present invention that the credit card issuer could assign various quantities of points to qualify for a entry ticket. Step 215, the credit card issuer will allocate the earned points to a credit card user based upon the dollars spent utilizing the credit card and the determined point allocation.

In step 217, the credit card issuer will convert the points to a prescribed amount of drawing tickets based upon the dollars spent on a user's credit card and the conversion ratio determined by the credit card issuer. Step 219, the credit card issuer creates a database wherein the entry tickets for the credit card holder are stored. In step 221, the credit card issuer will access the database utilizing a random protocol. Step 223, an entry ticket is selected from the database utilizing the aforementioned random protocol. In step 225, based upon the entry ticket selected by the random protocol, a credit card holder is identified as a winner of the drawing. Step 227, the identified winner is issued a payment by the credit card issuer. It should be understood within the scope of the present invention that the that the prize drawing(s) could occur at various intervals and be for alternate amounts.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A method for delivering rewards to a credit card holder wherein the method comprises the steps of:
issuing a credit card, wherein a financial institution issues the credit cards to credit card users;
identifying at least one organization, wherein the at least one organization is identified by at least one of the credit card users, wherein the at least one credit card user desired to facilitate a monetary donation to the at least one organization;
making at least one purchase, wherein the at least one credit card user utilizes the credit card to purchase a good or service;
generating points for the at least one purchase, wherein the financial institution generates a quantity of points based on the at least one purchase;
converting the points to a dollar value, wherein the points are converted to a dollar value by the financial institution;
requesting funding to the at least one organization, wherein the at least one of the credit card users request that the at least one organization receive monetary funding, wherein the monetary funding is derived from a point accumulation of the at least one credit card user;
transferring the monetary funding, wherein the financial institution transfers the monetary funding to the at least one organization;
receiving the monetary funding, wherein the at least one organization receives the monetary funding.

2. The method for delivering rewards to a credit card holder as recited in claim 1, and further including a step of reviewing a points accumulation total, wherein the at least one credit card user reviews the points accumulation total from a plurality of purchases.

3. The method for delivering rewards to a credit card holder as recited in claim 2, wherein the dollar value of the points are based upon a total amount spent by the at least one credit card user.

4. The method for delivering rewards to a credit card holder as recited in claim 3, and further including a step of generating a tax form receipt, wherein the tax form receipt is automatically generated by the financial institution and delivered to the at least one credit card user.

5. The method for delivering rewards to a credit card holder as recited in claim 4, wherein the tax form receipt provides a dollar value for a year that was paid to the at least one organization.

6. The method for delivering rewards to a credit card holder as recited in claim 5, and further including a step of determining a frequency for the monetary funding to be transmitted to the at least one organization, wherein the at least one credit card user stipulates a repeating term for the monetary funding to be performed.

7. A method for delivering rewards to a credit card holder wherein the method comprises the steps of:
issuing a credit card, wherein a financial institution issues the credit cards to credit card users;
conducting a plurality of purchases, wherein the credit card users utilize the credit card to purchase goods and services;
earning a multitude of points, wherein the multitude of points are earned based upon a dollar value of the plurality of purchases;
accumulating points, wherein points are accumulated for each of the credit card users from the plurality of purchases;
assigning a point identifier, wherein the point identifier is specific to each of the credit card users;
establishing a drawing, wherein the financial institution established routine drawings for a cash prize;
determining a point allocation, wherein the financial institution determines a quantity of points that can be converted into an entry ticket for the routine drawing;
allocating points, wherein the credit card users allocate how many of their accumulated points to be directed towards the entry tickets;
converting the allocated points, wherein the allocated points are converted into a quantity of entry tickets;
creating a database pool, wherein the financial institution creates a database pool to store all of the entry tickets for the credit card users;
accessing the database pool, wherein the financial institution accesses the database pool;
selecting one entry ticket, wherein the financial institution selects one entry ticket from the database pool;
identifying a winner of the routine drawing, wherein the winner is identified utilizing the point identifier;
paying the credit card user, wherein the financial institution pays the credit card user.

8. The method for delivering rewards to a credit card holder as recited in claim 7, wherein access of the database pool is performed in a random manner.

9. The method for delivering rewards to a credit card holder as recited in claim 8, wherein a value of the routine drawing is predetermined.

10. The method for delivering rewards to a credit card holder as recited in claim 8, wherein a value of the routine drawing is based upon a quantity of points allocated by the credit card users.
